(19) United States
(12) Patent Application Publication
(10) Pub. No.: US 2003/0171902 A1
(43) Pub. Date: Sep. 11, 2003

(54) Sequence data combining method, sequence data combining apparatus and sequence data combining program

(75) Inventor: Makihiko Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/353,000

(22) Filed: Jan. 29, 2003

(30) Foreign Application Priority Data
Mar. 6, 2002 (JP) 2002-059973

(51) Int. Cl. G06F 17/10

(52) U.S. Cl. 703/2

(57) ABSTRACT

Disclosed is a sequence data combining apparatus capable of creating, from pieces of sequence data that are classified into homology groups, information useful for bio researchers and so on. The sequence data combining apparatus includes a HMM creation unit which creates a probability model for each of the homology groups to be processed based on pieces of sequence data in each homology group, an identity value calculating unit which calculates, from each two probability models among the probability models created by said probability model creating step, an identity value which is an index of identity between the two probability models, and a combining unit which specifies similar homology groups based on the identity values calculated by the identity value calculation unit, and then creates a homology group by combining the specified homology groups.

### BACKGROUND OF THE INVENTION

1. Field of the Invention

The present invention relates to a sequence data combining method, a sequence data combining apparatus, and a sequence data combining program used for re-classifying pieces of sequence data that are classified into some homology groups.

The present disclosure relates to subject matter contained in Japanese Patent application No. 2002-59973 (filed on Mar. 6, 2002), which is expressly incorporated herein by reference in its entirety.

2. Description of the Related Art

In the fields of biotechnology, researches are carried out by using databases each containing a vast fund of information on DNA sequences and amino acid sequences.

Ordinary databases utilized for biotechnology researches contain many pieces of sequence data that are classified into groups called homology groups. However, there are databases containing several extremely similar homology groups, nevertheless databases in which pieces of sequence data are classified into larger groups (into fewer groups consisting of more pieces of sequence data) are suitable for some researches.

Accordingly, it is a primary object of the present invention, which was devised under such circumstances, to provide a sequence data combining method and a sequence data combining apparatus capable of creating, from pieces of sequence data that are classified into homology groups, more useful information for the bio researchers and so on.

It is another object of the present invention to provide a sequence data combining program capable of making a computer to combine some pieces of sequence data using the sequence data combining method of the present invention.

### SUMMARY OF THE INVENTION

To accomplish the above object, a sequence data combining method of the present invention includes a probability model creating step of creating a probability model for each of the homology groups based on pieces of sequence data in each homology group; an identity value calculating step of calculating, from each two probability models among the probability models created in the probability model creating step, an identity value which is an index of identity between the two probability models; and a homology group creating step of specifying similar homology groups based on the identity values calculated in the identity value calculation step, and of creating a homology group by combining the specified homology groups.

Namely, the sequence data combining method of the present invention is a method by which more useful information for bio researchers and so on is created, not by checking the identity of pieces of sequence data, but by combining some existing homology groups. Consequently, using this sequence data combining method, useful information for the bio researchers and so on can be prepared rapidly.

When implementing the sequence data combining method of the present invention, it is possible to adopt the probability model creating step in which an HMM (Hidden Markov Model) is created as the probability model or the probability model creating step in which the identity value is calculated using dynamic programming techniques. Further, it is possible to adopt the identity value calculating step, which involves creating a probability model for the created homology group.

A sequence data combining apparatus according to the present invention includes a probability model creating part for creating a probability model for each of the homology groups based on pieces of sequence data in each homology group; an identity value calculating part for calculating, from each two probability models among the probability models created by the probability model creating step, an identity value which is an index of identity between the two probability models; and a homology group creating part for specifying similar homology groups based on the identity values calculated by the identity value calculation step, and of creating a homology group by combining the specified homology groups.

That is, the sequence data combining apparatus according to the present invention is configured so as to be able to perform the sequence data combining method according to the present invention. Consequently, when using this sequence data combining apparatus of the present invention, it is possible to prepare useful information for the bio researchers and so on rapidly.

The sequence data combining program according to the present invention is configured(programmed) so that a computer can perform the sequence data combining method according to the present invention. Consequently, when using the program of the present invention, it is possible to prepare useful information for the bio researchers and so on rapidly.

### BRIEF DESCRIPTION OF THE DRAWINGS

These and other objects and advantages of the present invention will become clear from the following description with reference to the accompanying drawings, wherein:

FIG. 1 is a functional block diagram of a sequence data combining device of an embodiment of the present invention;

FIG. 2 is a diagram illustrating an HMM created by the sequence data combining device of this embodiment;

FIG. 3 is a diagram illustrating pairwise alignment using dynamic programming methods;

FIG. 4 is a diagram illustrating calculation results by the identity value calculating unit;

FIG. 5 is a diagram illustrating the homology group information-á from which HMM-á in FIG. 5 is created;

FIG. 6 is a diagram illustrating the homology group information-β from which HMM-β in FIG. 5 is created;

FIG. 7 is a diagram illustrating the homology group information-γ from which HMM-γ in FIG. 5 is created;

FIG. 8A is a diagram illustrating the relationship between HMM-α and HMM-γ;

FIG. 8B is a diagram illustrating the relationship between HMM-β and HMM-γ;

FIG. 8C is a diagram illustrating the relationship between HMM-β and HMM-γ;

FIG. 9 is a diagram illustrating the homology group information the combining unit creates.

### DETAILED DESCRIPTION OF THE PREFERRED EMBODIMENTS

The following is a detailed description with reference to the drawings of an embodiment of the present invention.

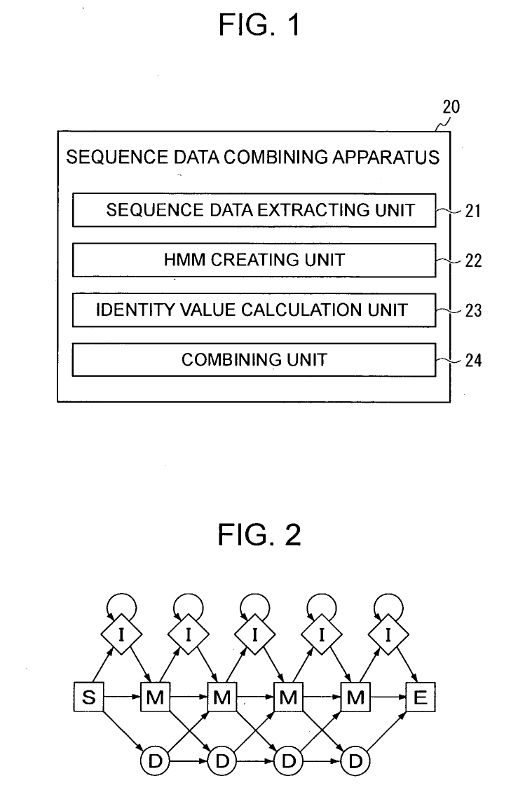

FIG. 1 is a functional block diagram of a sequence data combining device 10 of an embodiment of the present invention.

The sequence data combining apparatus 10 of this embodiment is realized as a device where a sequence data combining program is installed on a relatively high-performance computer. The sequence data combining apparatus 10 functions, as shown in this figure, as the device that comprises a sequence data extracting unit 21, an HMM creating unit 22, an identity value calculation unit 23, and a combining unit 24.

<Sequence Data Extracting Unit>

The sequence data extracting unit 21 is a unit for extracting, from a database on gene sequence and/or amino acid sequence, some pieces of homology group information (collection of pieces of sequence data that are classified into a homology group) that meet a retrieval condition inputted by an operator, and for storing the extracted information into an auxiliary storage (not shown in FIG. 1) in the sequence data combining apparatus 10. The sequence data extracting unit 21 starts the above processing when the operator performs operations including inputting operation of the retrieval condition to an input device of the sequence data combining apparatus 10.

Each piece of homology group information that the sequence data extracting unit 21 extracts is collection of pieces of multiple-alignmented sequence data. The multiple alignment is an operation (processing) for obtaining from three or more sequences new sequences in which elements are lined up in the most similar order by inserting gaps into appropriate locations of the sequences. In the following paragraphs, the term “alignment” is also used to describe the result of the alignment processing.

<Hmm Creating Unit>

The HMM creating unit 22 is a unit for creating an HMM (Hidden Malkov Model) from each piece of the homology group information extracted by the sequence data extracting unit 21.

As shown in FIG. 2, HMM is probability model that comprises M nodes, I nodes, D nodes, S nodes and E nodes made to correlate with each other via transition probability (shown by arrows in the figure).

The M nodes and I nodes constituting this HMM are nodes each expressing the state of a certain element of a sequence (or a sequence alignment). The M node is the node to which emission probability of the symbols (with HMMs expressing a base sequence there are four types of emission probability for four types of symbols referred to as A, G, C and T, and with HMMs expressing amino acid sequences, there are twenty types of emission probability) and the probability of a transition to several other nodes (M nodes, I nodes and D nodes) is assigned. The I node is the node, as with the M node, to which emission probabilities for a plurality of symbols and several transition probabilities to several other nodes are assigned. However, the probability of a transition to an own I node is made to correspond at the I node rather than the probability of a transition to another I node.

The D node is the dummy node to which no emission probability is assigned. Only the probabilities of transitions to several nodes are assigned to the D node. The S node is the node expressing the start state (initial state) of this HMM, and only the probabilities of transitions to several other nodes are assigned to this S node. The E node is the node expressing the end state (final state) of this HMM, and only emission probabilities are assigned to this E node.

Processing which HMM creating unit 22 does to create HMM is the same as the processing generally done. Therefore, the explanation of the creating procedure of HMM by the HMM creating unit 22 will be omitted.

<Identity Value Calculation Unit>

The identity calculation unit 23 (FIG. 1) is a unit for calculating, from each couple of HMMs (combination of two HMMS) among all HMMs created by the HMM creation unit 22, an identity value that is an index of identity of the couple of HMMS.

Arithmetic processing executed by the HMM creation unit 23 is a variation of arithmetic processing employing dynamic programming techniques carried out in the related art for pairwise alignment.

Therefore, first, a description of the arithmetic processing employing dynamic programming techniques will be given

Put in simple terms, pairwise alignment is an operation (processing) for obtaining two sequences in which elements are lined up in most similar order by inserting gaps into appropriate locations of two sequences that are to be processed.

An outline of pairwise alignment using dynamic programming techniques is now described giving an example of the case where pairwise alignment is carried out on two sequences (character strings) referred to as “AIMS” and “AMOS”.

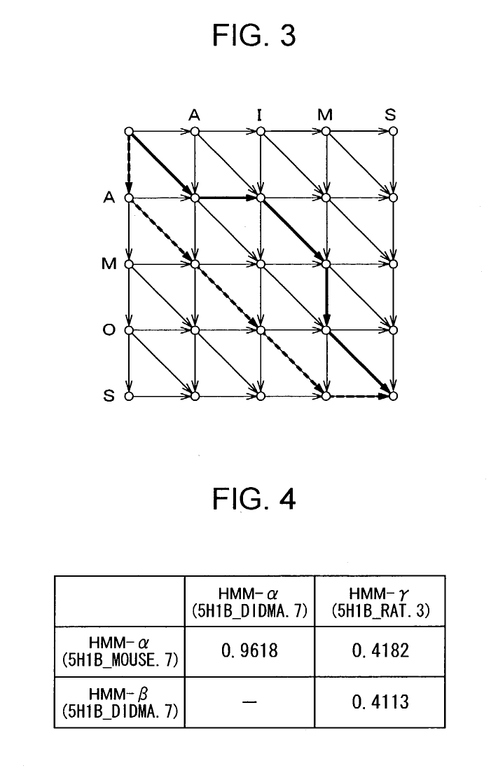

In this case, as shown schematically in FIG. 3, the existence of a matrix containing 5×5 nodes (circles) is assumed, with specific elements of one sequence (referred to in the following as a “first sequence” and in the drawings as “AIMS”) to be aligned being made to correspond to a group of nodes lined up in the vertical direction, and specific elements of a further sequence (referred to in the following as a “second sequence” and in the drawings as “AMOS”) of a second sequence to be aligned being made to correspond with nodes that are lined up horizontally.

When obtaining pairwise alignment, each migration path along the direction of the arrows from the node at the upper left end of the matrix to the node at the lower right end can be understood as one alignment (one alignment result for two series).

Specifically, with respect to the first sequence, movement along the arrows towards the right can be understood to be an operation of outputting elements (characters) made to correspond to nodes after movement as elements of alignment results, and with regards to the second sequence, movement to the right along the direction of the arrows can be understood to be an operation of outputting gaps as elements of alignment results. Further, with regards to both the first and second sequences, movement at an incline along the direction of the arrows can be understood as an operation for outputting elements (characters) made to correspond to nodes after movement as elements of alignment results. Regarding the first sequence, movement downwards along the direction of the arrows can be understood as an operation of outputting gaps as elements of alignment results, while regarding the second sequence, this movement can be understood as an operation of outputting elements (characters) made to correspond to nodes after movement as elements of alignment results.

Namely, in this figure, the path shown by the dotted line can be understood as showing “-AIMS” and “AMOS-”, while the path shown by the thick lined arrows can be understood as showing “AIM-S” and “A-MOS”.

If the most similar items are specified from all of the alignment results that this matrix expresses, then the optimal alignment can be obtained. However, with regards to all of the alignment results, it is desired to evaluate the extent to which the two sequences are similar after alignment, and obtaining the alignment that is the objective is time consuming.

In order to shorten this period of time, the following equation 1 (a recursive formula for i, j) is used for obtaining an evaluation point (evaluation value) for each path.

$${V}_{i , j} = [ \begin{matrix}{w}_{i , j} + {V}_{i - 1 , j - 1} \\ d + {V}_{i , j - 1} \\ d + {V}_{i - 1 , j}\end{matrix} ] \qquad eq . 1$$

In this equation 1, V_{i,j} is an evaluation point (evaluation value) for a path to a node making a first sequence element #i and a second sequence element #j correspond. { } is a function which outputs maximum element, and d is an evaluation point for a deficiency of corresponding elements referred to as “gap penalty” or “gap cost”. Further, w_{i,j} is an evaluation point relating to identity between the first sequence element #i and the second sequence element #j. Note that a value (one of two preset values) corresponding to whether or not both elements coincide is used as w_{i,j} when a base sequence is taken as a subject and a value read out from a table storing w values for each combination of two amino acids is used when an amino acid sequence is taken as the subject.

The calculation of equation 1 is then carried out for each node while increasing i, j while obtaining pairwise alignment using dynamic programming techniques. The optimum alignment is then obtained by storing which of the paths traced was the most appropriate (a plurality is also possible), and then, after completion of all the calculations, tracing the optimum path back (trace back) in reverse from the lower right end.

In short, the pairwise alignment employing dynamic programming techniques can therefore be completed at high speed, because carried out is a process in which every calculation of V value increases paths for which final evaluation points are not calculated (a process in which, with the max function { }, paths for two of three types of path capable of reaching this node are taken to be paths for which calculation of the final evaluation point is not carried out).

Next, a description is given of the operation of the HMM creation unit 23.

The HMM creation unit 23 is for subjecting the HMM to processing of the same theory as for the processing carried out in order to obtain pairwise alignment.

Specifically, in the identity value calculation processing executed by the identity value calculation unit 23, a matrix comprising (imax+1)×(jmax+1) nodes where emission probability vectors for an ith M nodes relating to HMM#0 (one of the two HMMs to be subjected to sequence data combining) are made to correspond to emission probability vectors for jth M nodes relating to HMM #1 (the other of the two HMMs to be subjected to sequence data combining) is assumed. Here, HMM#0 is one of the two HMMs to be subjected to sequence data combining, and HMM #1 is the other of the two HMMs, and imax is the number of M nodes for one of the HMM#0, and jmax is the number of M nodes of the HMM#1.

In the identity value calculation processing, evaluation values V_{i,j}, which is evaluation values for nodes (i, j) of the evaluation matrix, is calculated using equation 2 described in the following.

$${V}_{i , j} = [ \begin{matrix} \frac{S ( {M}_{i} , {M}_{j} ) + {V}_{i - 1 , j - 1}}{L} \\ \frac{d + {V}_{i , j - 1}}{{L}^{′}} \\ \frac{d + {V}_{i - 1 , j}}{{L}^{″}}\end{matrix} ] \qquad eq . 2$$

In the equation 2, d is so-called gap cost (gap penalty), and L, L′ and L″ are the numbers of the nodes that are passed through to reach node (i, j). The introduction of L, L′ and L″ is so that an evaluation value for a path inserted with a large number of gaps are inserted is a relatively small value.

Further, Mᵢ is an emission probability vector for ith M node of HMM#0, and Mᵢ is an emission probability vector for jth M node of HMM#1. S(Mᵢ, Mⱼ) is a function for obtaining an identity constituted by numerical information exhibiting this identity from the emission probability vector Mi and the emission probability vector Mⱼ. Any function may be employed as S(Mᵢ, Mⱼ) providing that a maximum value (for example, “1”) is taken when Mᵢ and Mⱼ are the same, and a minimum value (for example, “0”) is taken when Mᵢ and Mⱼ are completely different (when Mᵢ and Mⱼ are orthogonal). Namely, as shown in FIG. 4, the cosine cos(é) of the angle é between the vectors Mᵢ and Mⱼ or the cosine squared cos²(é) of the angle é can be used as S(Mᵢ, Mⱼ), but the HMM creation unit 23 of this embodiment employs the cosine squared cos²(é) of the angle é as S(Mᵢ, Mⱼ).

<Combining Unit>

The combining unit 24 is a unit for combining pieces of HG information extracted by the identity calculation unit 23, based on the calculation results by the identity calculation unit 21.

The combining unit 24 starts operation when the identity value calculation unit 23 finishes the calculation processing. The combining unit 24 tries to specify every couple of HMMs the identity value of which is lower than a predetermined identity threshold value. When the combining unit 24 specified one or more couple of HMMs, it starts combining processing for combining the specified couples of HMMs.

Hereinafter, the combining processing executed by the combining unit 24 is described giving an example of the case where the identity values calculated by the identity calculation unit is those shown in FIG. 4 and the identity threshold value is 0.9.

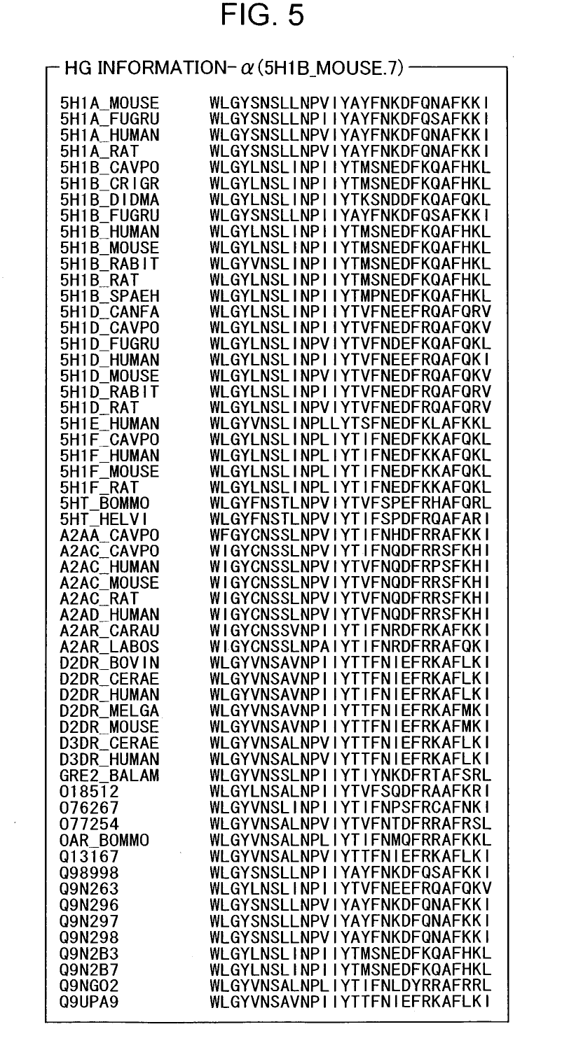

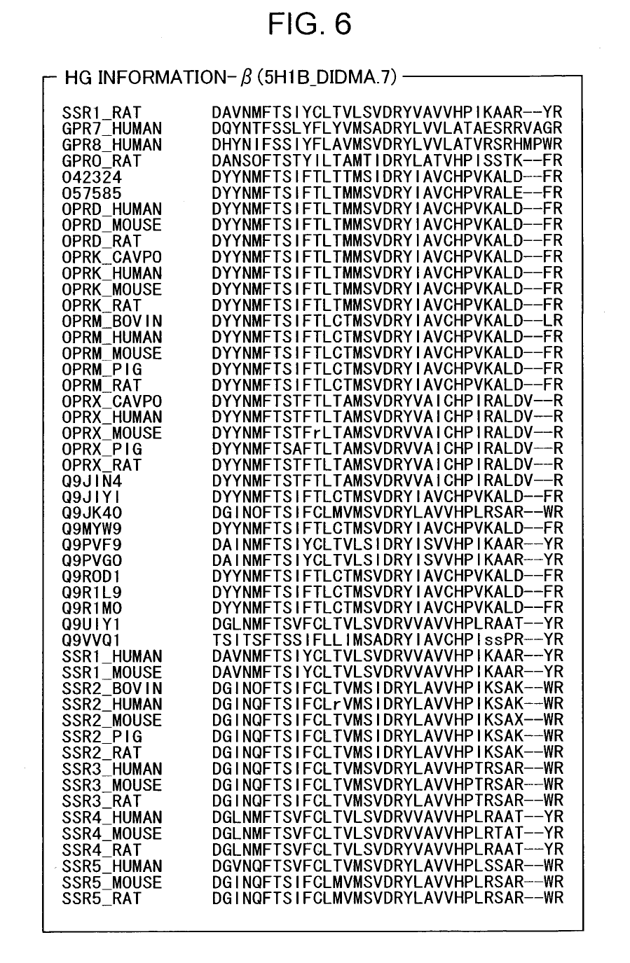

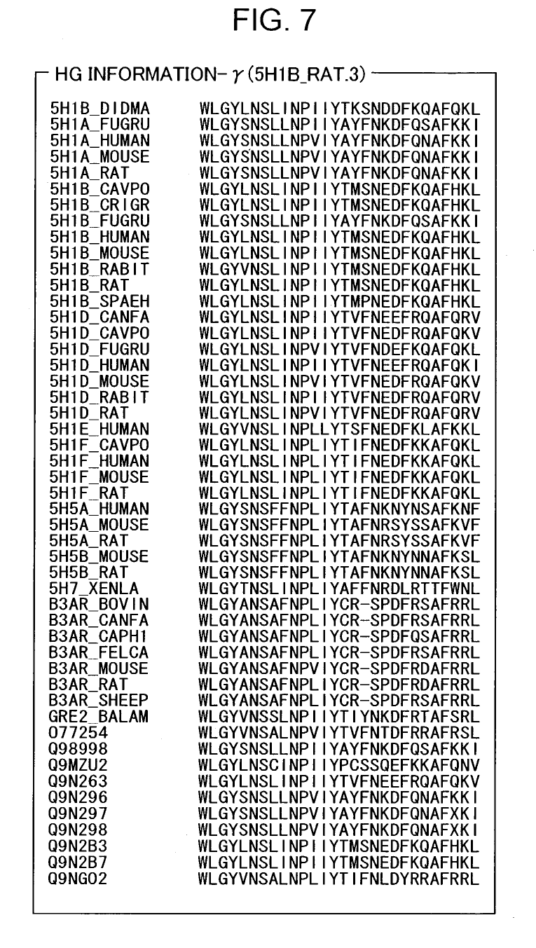

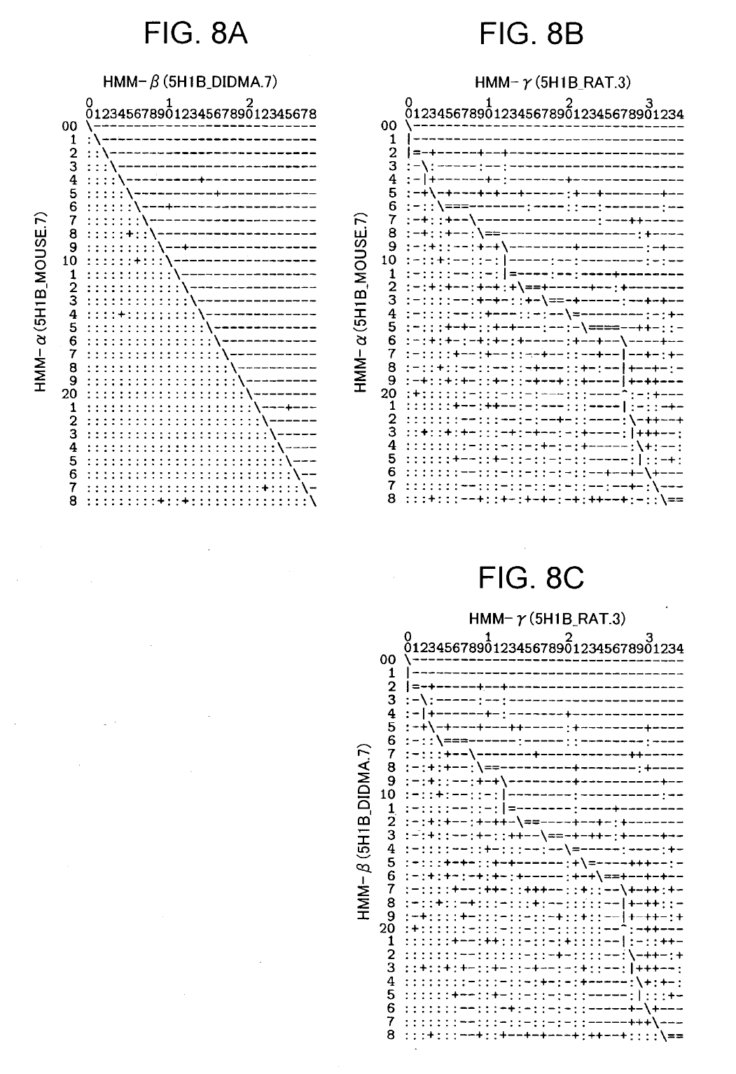

Here, that the HMM-α, HMM-β, and HMM-γ in FIG. 4 are HMMs created by the HMM creation unit 22 from HG information-a (5H1A_MOUSE.7) shown in FIG. 5, HG information-β (5H1B_DIDMA.7) shown in FIG. 6, and HG information-β (SSR1_RAT.3) shown in FIG. 7, respectively. And the HMM-α and HMM-β, the HMM-α and HMM-γ, the HMM-β, and HMM-γ are the HMMs having the relationship shown in FIGS. 8A-8C, which showing the back trace results of the identity calculation processing by the identity value calculation unit 23, respectively. Incidentally, in FIG. 8A-8C, portions described by “\”, “|”, “=” are back traced portions, and the portions described by “\”, “|”, “=” are portions connected by diagonal, up, and sideways (left), respectively. Further, portions described by each of the symbols “+”, “:” and “−” are non-back traced portions and show portions connected from diagonal, up, sideways (left).

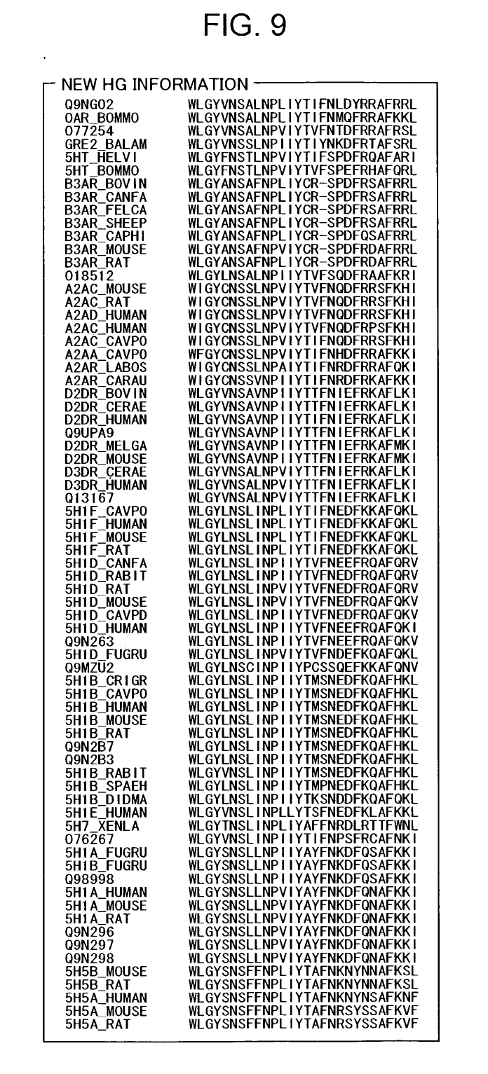

In this case, only the identity value of the couple of HMM-α and HMM-β is higher than the identity threshold value. Therefore, the combining unit 24 extracts from the HG information-α and the HG information-β all sequence data but without no duplication. The combining unit 24, thereafter, executes multiple alignment processing to the extracted sequence data, thereby creating new HG information as shown in FIG. 9, and stores the created HG information into the auxiliary storage. Further, the combining unit 24 creates HMM from the created HG information and stores the created HMM into the auxiliary storage and then terminates the processing.

As described in detail above, according to the sequence data combining apparatus 10 of this embodiment is configured so as to be able to retrieve similar HG information from pieces of HG information, and combine the retrieved two or more pieces of HG information. In other words, the sequence data combining apparatus 10 is configured so as to create some pieces of new HG information which are more useful information for the bio researchers and so on, not by checking the identity of pieces of sequence data, but by combining some pieces of existing HG information. Furthermore, the sequence data combining apparatus 10 has the ability to create the HMM of the created HMM information. Therefore, if this sequence data combining apparatus 10 is used, it is possible to prepare useful information on gene sequence and the likes for the bio researchers and so, rapidly.

<Modification>

Various modifications are possible for the sequence data combining apparatus 10 described above. For example, the sequence data combining apparatus 10 is configured so as to calculate V_{i,j} using eq. 2. In other words, the sequence data combining apparatus 10 is configured so as to calculate the identity value of the two HMMs considering only the emission probabilities assigned to M nodes. However, the sequence data combining apparatus 10 can be modified so as to calculate V_{i,j} using eq. 3 instead of eq. 1.

$${V}_{i , j} = [ \begin{matrix} \frac{S ( {T}_{i} , {T}_{j} ) \cdot S ( {M}_{i} , {M}_{j} ) + {V}_{i - 1 , j - 1}}{L} \\ \frac{d + {V}_{i , j - 1}}{{L}^{′}} \\ \frac{d + {V}_{i - 1 , j}}{{L}^{″}}\end{matrix} ] \qquad eq . 3$$

In eq. 3, Ti is a transition probability vector for ith M node of HMM#0, and Tj is an emission probability vector for jth M node of HMM#1. S(Tᵢ, Tⱼ) is the identity between the two transition probability vectors (S(Tᵢ, Tⱼ) is cosine squared of the angle made by the two vectors).

The sequence data combining apparatus 10 can be also modified so as to calculate V_{i,j} using equations 4 to 7 instead of eq. 1.

$$\begin{matrix}{V}_{i , j} = [ \begin{matrix}\frac{{Sim}_{i , j} + {V}_{i - 1 , j - 1}}{L} \\ \frac{max ( d , {D1}_{i , j - 1} ) + {V}_{i , j - 1}}{{L}^{′}} \\ \frac{max ( d , {D2}_{i - 1 , j} ) + {V}_{i - 1 , j}}{{L}^{″}}\end{matrix} ] & eq . 4 \\ {Sim}_{i , j} = \frac{{Tm}_{i} \cdot {Tm}_{j} \cdot S ( {M}_{i} , {M}_{j} ) + {Ti}_{i} \cdot {Ti}_{j} \cdot S ( {I}_{i} , {I}_{j} ) + {Td}_{i} \cdot {Td}_{j}}{\vert {T}_{i} \vert \cdot \vert {T}_{j} \vert} & eq . 5 \\ {D1}_{i , j} = \frac{{Ti}_{i} \cdot {Tm}_{j} \cdot S ( {I}_{i} , {M}_{j} ) + {Tm}_{i} \cdot {Td}_{j}}{\vert {T}_{i} \vert \cdot \vert {T}_{j} \vert} & eq . 6 \\ {D2}_{i , j} = \frac{{Ti}_{j} \cdot {Tm}_{i} \cdot S ( {I}_{j} , {M}_{i} ) + {Tm}_{j} \cdot {Td}_{i}}{\vert {T}_{i} \vert \cdot \vert {T}_{j} \vert} & eq . 7\end{matrix}$$

In these equations, Tmᵢ, Tiᵢ and Tdᵢ are the probability of a transition to an M node, the probability of a transition to an I node, and the probability of a transition to a D node, respectively, with regards to ith M node of the HMM#0. Tmⱼ, Tiⱼ and Tdⱼ are the probability of a transition to an M node, the probability of a transition to an I node, and the probability of a transition to a D node, respectively, with regards to jth M node of the HMM#1. Iᵢ is an emission probability vector for ith node of HMM#0, and Iⱼ is an emission probability vector for jth I node of HMM#1.

Moreover, the sequence data combining apparatus 10 can be configured using the combining unit 24 operates as follows.

The combining unit 24, when the operation of the identity value calculation unit 23 ends, displays the standby screen in the display device. Here, the standby screen is a screen where frequency distribution information on the identity values and the current threshold value are shown. In other words, the standby screen is a screen which allows the operator to know how many pieces of HG information will be combined by the current threshold value.

After displaying the standby screen, the combining unit 24 goes into a standby state where it wait for input of a change instruction indicating to change the identity threshold value, an execution instruction indicating to start combining processing and so on.

When the change instruction is input, the combining unit 24 displays a screen for prompting the operator to input the identity threshold value, and goes int a state where it waits for input of the identity threshold value. When the identity threshold value is input, the combining unit 24 stores the inputted identity threshold value. Thereafter, the combining unit 24 displays the standby screen where the inputted identity threshold value is shown in the display device, and goes back into the standby state.

When the execution instruction is input, the combining unit 24 specifies each couple of HMMs whose identity values is higher than the identity threshold values. And, the combining unit 24, when it specified at least one couple of HMMs, executes the combining processing of combing pieces of HMM information related to the specified one or more couple of HMMs.

In short, the sequence data combining apparatus 10 can be configured so as to operate interactively.

Further, the sequence data combining apparatus 10 is a device where the sequence data combining program is installed on a computer. It is possible to realize the sequence data combining apparatus 10 having an IC that operates as the identity value calculation unit 23 and so on. The technology employed in the sequence data combining apparatus 10 may also be applied to probability models other than HMMs. Moreover, portable record medium (CD-ROM and MO, etc.) recording the sequence data combining program may be distributed (soled) to a person who want it.

What is claimed is:

1. A sequence data combining method for re-classifying two or more pieces of sequence data that are classified into several homology groups, including:
a probability model creating step of creating a probability model for each of homology groups to be processed based on pieces of sequence data in each homology group;
an identity value calculating step of calculating, from each two probability models among the probability models created in said probability model creating step, an identity value which is an index of identity between the two probability models; and
a homology group creating step of specifying similar homology groups based on the identity values calculated in said identity value calculation step, and of creating a homology group by combining the specified homology groups.

2. The sequence data combining method according to claim 1, wherein the probability model created in said probability model creating step is a Hidden Markov Model.

3. The sequence data combining method according to claim 1, wherein the identity value calculating step is a step of calculating the identity value using dynamic programming techniques.

4. The sequence data combining method according to claim 1, wherein the identity value calculating step involves creating a probability model for the created homology group.

5. A sequence data combining apparatus for re-classifying two or more pieces of sequence data that are classified into several homology groups, including:
a probability model creating part for creating a probability model for each of homology groups to be processed based on pieces of sequence data in each homology group;
an identity value calculating part for calculating, from each two probability models among the probability models created by said probability model creating part, an identity value which is an index of identity between the two probability models; and
a homology group creating part for specifying similar homology groups based on the identity values calculated by said identity value calculating part, and of creating a homology group by combining the specified homology groups.

6. The sequence data combining apparatus according to claim 5, wherein the probability model created by said probability model creating part is a Hidden Markov Model.

7. The sequence data combining apparatus according to claim 5, wherein the identity value calculating part calculates the identity value using dynamic programming techniques.

8. A sequence data combining program causing a computer to execute a process, said process comprising:
a probability model creating step of creating a probability model for each of homology groups to be processed based on pieces of sequence data in each homology group;
an identity value calculating step of calculating, from each two probability models among the probability models created in said probability model creating step, an identity value which is an index of identity between the two probability models; and
a homology group creating step of specifying similar homology groups based on the identity values calculated in said identity value calculating step, and of creating a homology group by combining the specified homology groups.

9. The sequence data combining program according to claim 8, wherein the probability model created in said probability model creating step is a Hidden Markov Model.

10. The sequence data combining apparatus according to claim 8, wherein the identity value calculating step is a step of calculating the identity value using dynamic programming techniques.

11. A sequence data combining apparatus for re-classifying two or more pieces of sequence data that are classified into several homology groups, including:
probability model creating means for creating a probability model for each of homology groups to be processed based on pieces of sequence data in each homology group;
identity value calculating means for calculating, from each two probability models among the probability models created by said probability model creating means, an identity value which is an index of identity between the two probability models; and
homology group creating means for specifying similar homology groups based on the identity values calculated by said identity value calculating means, and of creating a homology group by combining the specified homology groups.
